(19) United States
(12) Patent Application Publication
(10) Pub. No.: US 2013/0298121 A1
(43) Pub. Date: Nov. 7, 2013

(54) Method for Isolated Use of Browser

(71) Applicants: Hongyi Zhou, Beijing (CN); Hongwei Liu, Beijing (CN)

(72) Inventors: Hongyi Zhou, Beijing (CN); Hongwei Liu, Beijing (CN)

(73) Assignee: BEIJING QIHOO TECHNOLOGY COMPANY LIMITED, Beijing (CN)

(21) Appl. No.: 13/885,628

(22) PCT Filed: Nov. 16, 2011
(86) PCT No.: PCT/CN2011/082270

§ 371 Date: Jul. 18, 2013

(30) Foreign Application Priority Data
Nov. 19, 2010 (CN) 201010552562.9

(51) Int. Cl. G06F 9/455

(52) U.S. Cl. CPC G06F 9/455
USPC 718/1

(57) ABSTRACT

The present invention provides a method for isolated use of browser comprising: establishing a virtual environment in a user's computer system by a browser; arranging content loaded by the browser in the virtual environment; processing operation results in the virtual environment.

### FIELD OF THE INVENTION

The present invention relates to a field of computer security, and particularly to a method for isolated use of browser.

### BACKGROUND OF THE INVENTION

In order to provide richer functions, more and more client-side scripting and component techniques are used in a Web page. In this respect, this brings better functions and user experience. Meanwhile, this also makes the user face more security problems when using browser software.

JavaScript technique has become a de facto standard, and naturally is also the main target utilized by the malicious softwares. Because the access scope and authority of the JavaScript to an operating system is limited relatively strictly, it is very hard to utilize JavaScript to implement destruction directly. But the downloader program often utilizes the

JavaScript to download actual attack codes from the Internet.

As an important technique for interaction between browser software and other platforms, ActiveX also has a long history of security problems. As having stronger capability of manipulating the system than the browser script, virus based on ActiveX component often has more destructivity, and furthermore can directly attack the operating system. Many enterprise-level software systems select the ActiveX component as a core technique for realizing client-side functions, which makes the construction of security protection system more complex. Besides, by means of the VBScript of Windows Script Host and Java Applet which has been less used currently, etc, destructive activities can be performed based on the browser.

It is also to be noted that as the most commonly-used application program in desktop computers, the browser is more and more closely combined with the operating system currently. Besides the IE browser closely integrated with the Windows operating system, other browsers also utilize many underlying components of the operating system to improve their own function value. It is also the major reason why the security attack utilizing the browser problem can be so destructive, and many bugs allow the attack code to directly destroy or utilize the core of the operating system. Particularly, for those 0 day attacks for which the manufactures haven't released update patch, the desktop computer would be totally exposed to these attacks and almost defenseless.

Facing so many attack possibilities, for browser users, especially for users who are not familiar with the network or even know little about computer, they always seem not to know what to do. In many cases, the webpage, in which there are data or files needed by the user, contains Trojan horse virus and malicious code, but the user not only wants to download these useful data but also wants to prevent the computer system from being damaged. The existing browsers cannot meet such requirements.

### SUMMARY OF THE INVENTION

To this end, in order to solve the abovementioned problem, the present invention provides a method for isolated use of browser.

For achieving the abovementioned purpose, the present invention provides a method for isolated use of browser comprising: establishing a virtual environment in a user's computer system by a browser; arranging content loaded by the browser in the virtual environment; processing operation results in the virtual environment.

Preferably, certain system resources are arranged for the virtual environment, and the method further comprises: invoking the certain system resources when the computer system is powered on or the browser is launched.

Preferably, the browser makes use of the system resources when loading the content in the browser, and the process of arranging content loaded by the browser in the virtual environment further comprises: redirecting the browser's system resource operation to the virtual environment pre-established.

Preferably, the virtual environment pre-established is a temporary folder pre-created, and in the method a disk write operation of the browser is redirected to the temporary folder pre-created; or operations, files or resources to be written into the system are written into a specially-designed file with a private format; or part of the operations is redirected; or a complete virtual environment is established.

Preferably, the browser's system resource operation comprises disk write or read operation, write or read operation to the system resources, write or read operation to system configuration settings, or interactive operation with an application software being running in the current system.

Preferably, the isolated use of browser is triggered by the user actively or triggered by the browser's analysis of a network address or webpage content.

Preferably, the process of arranging the content loaded by the browser in the virtual environment further comprises processing the operation results in the virtual environment, and the process of processing the operation results in the virtual environment comprises: judging whether the browser's system resource operation is a legal operation; and for the legal operation, not redirecting the browser's system resource operation to the virtual environment pre-established.

Preferably, the browser's system resource operation comprises disk write operation, and the virtual environment pre-established is a temporary folder pre-created, and the method does not redirect the legal disk write operation of the browser to the temporary folder pre-created.

Preferably, the method further comprises: closing the virtual environment.

Preferably, the process of closing the virtual environment comprises: closing the virtual environment immediately, closing the virtual environment after a time delay, closing the virtual environment when the browser is launched next time, or resetting and cleaning up the content in the virtual environment.

The present invention also provides an apparatus for isolated use of browser, and the apparatus comprises: a module configured to establish a virtual environment in a user's computer system by the browser; a module configured to arrange content loaded by the browser in the virtual environment; and a module configured to process operation results in the virtual environment.

Preferably, the module configured to arrange the content loaded by the browser in the virtual environment redirects the browser's system resource operation to the pre-established virtual environment.

Preferably, the apparatus further comprises: a module configured to judge whether the browser's system resource operation is a legal operation, and for the legal operation, not to redirect the browser's system resource operation to the pre-established virtual environment.

Preferably, the apparatus further comprises: a module configured to close the virtual environment.

The present invention further provides a computer readable recording medium on which is recorded a program for executing the abovementioned method for isolated use of browser.

Through establishing the virtual environment in the computer system according to the embodiments of the present invention, the whole running content of the browser is loaded into this virtual environment, which makes it isolated from the real environment. Thus, the user can selectively determine the storage of a file and whether to change the settings in the real environment. The present invention ensures the security and reliability of the user system, and meantime, it can allow the user to safely obtain the desired content.

### BRIEF DESCRIPTION OF THE DRAWINGS

FIG. 1 is a flow chart of a method according to a specific embodiment of the present invention.

FIG. 2 is a schematic view of a specific embodiment of the application environment of the present invention.

### DETAILED DESCRIPTION OF EMBODIMENTS

Various internet frauds, represented by phishing, are part of the main security threats at present. In the Microsoft 1E8 browser, a unique improvement in functionality is provided. After the user inputs a website address in the address bar of the browser, the 1E8 would identify the top level domain part in the website address and display it in a highlight way. Although this improvement seems very small, it is unexpectedly effective in practice. This can obviously focus the user's attention, thereby the user can judge whether he inputs the website address correctly. Meantime, the enhanced security filter provided in the 1E8 can also complete the analysis of the website address. The most important is that by setting the security policy, the protection level of this security filter can be increased and thus access to the suspicious websites can be blocked to a greater degree.

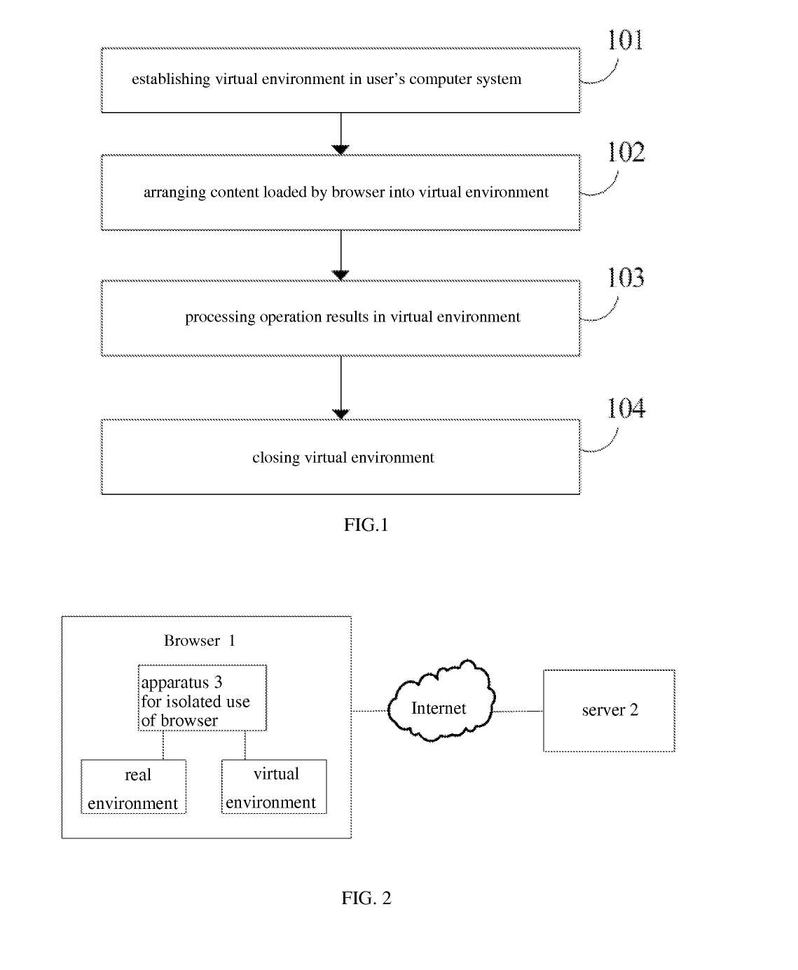

However, this is still a kind of passive defense after all, and if the user requires a browser application environment with absolute security, such method cannot satisfy this kind of user requirement. Therefore, the present invention provides a method for isolated use of browser, as shown in FIG. 1, comprising the following steps.

In step 101, the browser establishes a virtual environment in a user's computer system.

When the user needs to protect his system, the method for isolated use of browser can be started at any time, such as starting an isolation mode when the browser is launched. The isolation mode can also be started during using the browser. After starting the method for isolated use of browser, the browser will establish the virtual environment in the user's computer system.

In step 102, content loaded by the browser is arranged in the virtual environment.

The basic procedure of loading a page in the browser is as follow:

1. The user inputs a website address (assuming it is a html page and visited for the first time), and the browser sends a request to a server and the server returns a html file back;

2. The browser begins loading the html code, and a <link> tag inside a <head> tag may reference an external CSS file;

3. The browser sends a request for the CSS file and the server returns this CSS file back;

4. The browser continues to load the code in the <body> part of the html file, and begins to render the page;

5. When the browser finds in the code that an <img> tag references an image, it sends a request to the server in order to obtain this image. Here, the browser would not wait until the image is completely downloaded, but continues to render the rest of the code;

6. The server returns the image file back. As the image occupies a certain area, which affects the layout of the paragraphs thereafter, the browser needs to come back to render this part of the code again;

7. When the browser finds a <script> tag containing a line of JavaScript code, it runs this JavaScript code;

8. The browser renders the page from top to bottom until it meets a </html> tag.

It can be found that upon displaying a page, the browser would continuously obtain files from the server and write such filed obtained into the local system. Various attacks to the browser generally need to control the user's computer resources. However, during the control of user's computer resources, it's inevitable to operate the user's computer resources. Therefore, the security of the local system will be ensured if the write operation to the local system by the browser is controlled.

The operations of resources of the user's computer comprise various disk write operations. Operations such as writing disk, deleting, renaming, modifying the registry all might cause the user's computer infected. Thus in a specific embodiment of the present invention, each of the abovementioned disk write operations is directed into a preset temporary folder which is controllable. Thus, any kind of write operation is redirected into this temporary folder and is finally executed in the temporary folder.

Besides the various disk write operations, the operations to the user's computer resource also comprise the following content.

1. Disk read operation. As reading the user's disk would cause the leakage of the user's important information, the operation of reading the disk needs to be controlled;

2. Read and write operation to the system resources. For example, the read and write to the registry is also means by which many Trojan viruses are implanted, therefore sometimes read and write operation to the system resources is more important;

3. Read and write operation to the system configuration setting;

4. Interaction with the application software being running in current system, which comprises the injection of related processes. For example, an instant messenger software is running in a real environment of the current system, and a link can be clicked through the interface of this instant messenger software, and this is a kind of interaction with application software. If the browser verifies this link to be suspicious, it can arrange the operation of loading this link's content in the virtual environment.

If necessary, these abovementioned operations to the user's computer resources all can be arranged in the virtual environment, thus the security of the computer system is ensured.

In a specific embodiment, the browser still runs in the real environment, whereas the resources invoked by the browser for the operations are all used in the virtual environment. The operation to the system resources by the browser comprises disk write operation. The pre-established virtual environment is a pre-created temporary folder and the method redirects the disk write operation of the browser to the pre-established temporary folder.

The temporary folder can be created in the disk, or it can also be created in the memory. The temporary folder may comprise one or more folders, or one folder may also be created for each respective kind of operation. Therefore, the position and form for setting the temporary folder cannot limit the scope of the present invention. Therefore, such a manner that data can only enter in a unidirectional way prevents the system well from attacks of virus from unknown sources.

The virtual environment is not limited to the creating of the folder, and it further comprises creating of a virtual machine, which enables the whole browser to run in the virtual environment.

In another specific embodiment, the method for creating the virtual machine is: by mean of a virtual machine software, creating a virtual operating system in the memory of the user terminal, and arranging the whole operating system in the virtual machine. Thus, loading the browser and various write operations of the browser are only effective in the virtual operating system. Therefore, it can ensure the local system resources not to be effected.

The virtual environment may also be established by writing the operations, files, resources to be written into the system, into a specially-designed file with a private format; or by redirecting part of the operations, such as installing drivers, accessing the system's critical resources, writing into temporary file or the like.

The system resources required by the virtual environment may run when the user's computer system is powered on or the browser is launched. It is determined by the user whether to arrange the loaded content of the browser in the virtual environment. When the user needs to protect his own system, he may start the method for isolated use of browser at any time.

In a specific embodiment, the browser analyzes the website address or webpage content. When it finds potential risks, the browser actively starts the method for isolated use of browser. Alternatively, the browser prompts the user whether to start the method for isolated use of browser.

In step 103, operation results in the virtual environment are processed.

Not all operations to the virtual environment only take effect in the virtual environment. If all the operations to the system resources occur in the virtual environment, virus attacks can certainly be defended, but much content needed by the user, such as images, texts, documents or the like needed by the user, would not be stored in the system into the real environment.

Therefore, the step of processing the operation results in the virtual environment according to the present invention further comprises the following steps.

In step 201, judgment is made about whether the browser's system resource operation is a legal operation.

In step 202, for the legal operation, the browser's system resource operation is not redirected to the pre-established virtual environment.

Since some of the operation results in the virtual environment are needed by the user, the communications between the virtual environment and the real environment cannot be thoroughly blocked. But during the inter-communications process between the virtual environment and the real environment, it is necessary to verify whether the operation is legal. If it is legal, the operation is switched from the virtual environment to the real environment or from the real environment to the virtual environment.

In a specific embodiment, when synchronizing save-type operations to the real environment, or taking the operation to the system effective in the real environment, the user only needs to set these operations as legal operations. Thus, the disk write operations for these legal operations would not be redirected into the preset temporary folder.

In another specific embodiment, a modification to the registry may be needed by user. Therefore, all modifications to the registry are not redirected into the preset temporary folder, so that this kind of operations can be ensured to be implemented in the real environment.

In step 104, the virtual environment is closed.

As the virtual environment will consume certain system resources maintenance for example, needing to take disk space or memory, and many operations to the disk cannot occur in the real environment, there is a need to close the virtual environment at a proper time. The method for closing the virtual environment may be closing the virtual environment immediately, closing the virtual environment after a time delay, closing the virtual environment when the browser is launched next time or resetting and cleaning up the content in the virtual environment.

In a further specific embodiment, closing the virtual environment is deleting the preset temporary folder.

According to the invention, the data processed by the browser is processed in a safe manner by means of the virtual environment, and thus the real environment is prevented from attacks.

Based on the abovementioned content, the embodiment in the present invention also provides an apparatus for isolated use of browser, and the apparatus can be implemented as independent client-side software, such as plug-in, which can be invoked by a general browser. The apparatus can also be directly embedded in the browser so that the browser has the function of isolated use.

Specifically, the apparatus for isolated use of browser comprises: a module 10 configured to establish the virtual environment in the user's computer system by the browser;

a module 20 configured to arrange the content loaded by the browser in the virtual environment;

a module 30 configured to process the operation results in the virtual environment.

Preferably, in another specific embodiment, certain system resources are arranged for the virtual environment, and the apparatus further comprises: a module configured to invoke the certain system resources when the computer system is powered on or the browser is launched.

Preferably, in another specific embodiment, the module 20 may redirect the operations of the browser to the system resources to the pre-established virtual environment.

Preferably, in another specific embodiment, the pre-established virtual environment is a pre-created temporary folder, and the module 20 redirects the disk write operation of the browser to the pre-created temporary folder, or writes the operations, files, resources to be written into the system into a specially-designed file with a private format, or redirects part of the operations, or establishes a complete virtual environment.

Preferably, in another specific embodiment, the browser's system resource operation comprises disk write or read operation, write or read operation to the system resources, write or read operation to system configuration settings, or interactive operation with an application software being running in the current system.

Preferably, in another specific embodiment, the isolated use of browser is triggered by the user actively or triggered by the browser's analysis of a network address or webpage content.

Preferably, in another specific embodiment, the apparatus further comprises: a module configured to judge whether the browser's system resource operation is a legal operation, and not to redirect the browser's system resource operation into the pre-established virtual environment for the legal operation.

Preferably, in another specific embodiment, the browser's system resource operation comprises disk write operation. The pre-established virtual environment is a pre-created temporary folder. The apparatus does not redirect the legal disk write operation of the browser to the pre-created temporary folder.

Preferably, in another specific embodiment, the apparatus further comprises a module configured to close the virtual environment.

Preferably, in another specific embodiment, the closing the virtual environment comprises: closing the virtual environment immediately, closing of the virtual environment after a time delay, closing the virtual environment when the browser is launched next time, or resetting and cleaning up the content in the virtual environment.

For the embodiments of abovementioned apparatus for isolated use of browser, as it is basically similar with the embodiments about the method, it is simply described, and reference can be made to the description of the embodiment about the method as shown in FIG. 1.

The abovementioned apparatus for isolated use of browser can be applied in the following environment, as shown in FIG. 2.

In this application environment, during communication between the browser 1 and a server 2 through the Internet, once the apparatus 3 for isolated use of browser, as an independent plug-in or partial structure of the browser 1 itself, is started, the virtual environment can be established in the user's computer system, and the loaded content of the browser is arranged in the virtual environment, and the operation results in the virtual environment are processed, so that the virtual environment is isolated from the real environment.

Furthermore, because some of the operation results in the virtual environment are needed by the user, therefore the apparatus 3 for isolated use of browser cannot thoroughly block the communications between the virtual environment and the real environment.

The present invention ensures the security and reliability of the user system, and meantime it enables the user to safely obtain the content he needs.

Based on the abovementioned content, the embodiments in the present invention also provide a computer readable recording medium on which a program for executing the method for isolated use of browser is recorded, wherein for the details of the method for isolated use of the browser, reference can be made to the content stated in the embodiment shown in FIG. 1, and detailed description will not be presented again.

The computer readable recording medium comprises any mechanism for storing or transferring information in a computer (such as computer) readable form. For example, the machine readable medium comprises read only memory (ROM), random access memory (RAM), disk storage medium, optical storage medium, flash storage medium, transmission signal in the form of electricity, light, sound or others (for example, carrier, infrared signal, digital signal, etc.) , etc.

The present invention can be used in many common or specific computer system environments or configurations. For example, personal computer, server computer, handheld device or portable device, flat type device, multi-processor system, system based on micro-processor, set top box, programmable consumer electronic devices, network PC, minicomputer, large scale computer, distribution computing environment comprising any above system or device, and etc.

The present invention can be described in general context of the computer executable command which is executed by computer, for example, program module. Generally, program module comprises routine, program, object, component, and data structure which execute certain task or realize certain abstract data type and so on. It can also practice the present application in the distribution computing environments. In these distribution computing environments, remote processing device which is connected through the communications network performs the task. In the distribution computing environments, program module can be located in local and remote computer storage medium which comprises storage device.

In the present invention, “component”, “apparatus”, “system” and so on refers related entity that is applied in the computer, such as hardware, the combination of the hardware and software, software or software in running and so on. To be specific, for example, component can be but not limited to process run in processor, processor, object, executable component, executed thread, program and/or computer. Also, application program or script program run on the server, and the server all can be component. One or more components can be in running procedure and/or thread, and the components can be localization in one computer and/or distributed between two or more computers, and can be executed by various computer readable medium. Through local and/or remote procedure, the components can also communicate according to signal having one or more data packets, for example, signal of data from interaction with another component in local system, distribution system, and/or interaction with other system through signal in internet network.

The above description is only preferred embodiments of the present invention and is not used to limit the present invention. Any modification, equivalent substitution and so on within the spirit and principle of the present invention should be contained in the protection scope of the present invention.

1. A method for isolated use of browser, comprising:
establishing a virtual environment in a user's computer system by a browser;
arranging content loaded by the browser in the virtual environment;
processing operation results in the virtual environment.

2. The method of claim 1, wherein certain system resources are arranged for the virtual environment,
and the method further comprises:
invoking the certain system resources when the computer system is powered on or the browser is launched.

3. The method of claim 2, wherein the browser makes use of the system resources when loading the content in the browser, and
the process of arranging content loaded by the browser in the virtual environment further comprises:
redirecting the browser's system resource operation to the virtual environment pre-established.

4. The method of claim 3, wherein the virtual environment pre-established is a temporary folder pre-created, and in the method a disk write operation of the browser is redirected to the temporary folder pre-created; or
operations, files or resources to be written into the system are written into a specially-designed file with a private format; or
redirecting part of the operations; or
establishing a complete virtual environment.

5. The method of claim 3, wherein the browser's system resource operation comprises:
disk write or read operation, write or read operation to the system resources, write or read operation to system configuration settings, or interactive operation with an application software being running in the current system.

6. The method of claim 1, wherein the isolated use of the browser is triggered by the user actively or triggered by the browser's analysis of a network address or webpage content.

7. The method of claim 1, wherein the process of arranging content loaded by the browser in the virtual environment further comprises processing the operation results in the virtual environment,
and the process of processing the operation results in the virtual environment comprises:
judging whether the browser's system resource operation is a legal operation; and
for the legal operation, not redirecting the browser's system resource operation to the virtual environment pre-established.

8. The method of claim 7, wherein the browser's system resource operation comprises disk write operation, and the virtual environment pre-established is a temporary folder pre-created, and the method does not redirect the legal disk write operation of the browser to the temporary folder pre-created.

9. The method of claim 1, further comprises: closing the virtual environment.

10. The method of claim 9, wherein the process of closing the virtual environment comprises:
closing the virtual environment immediately;
closing the virtual environment after a time delay;
closing the virtual environment when the browser is launched next time; or
resetting and cleaning up the content in the virtual environment.

11. An apparatus for isolated use of browser, comprising:
a module configured to establish a virtual environment in a user's computer system by a browser;
a module configured to arrange content loaded by the browser in the virtual environment;
a module configured to process operation results in the virtual environment.

12. The apparatus of claim 11, wherein the module configured to arrange the content loaded by the browser in the virtual environment redirects the browser's system resource operation to the virtual environment pre-established.

13. The apparatus of claim 11, further comprising a module configured to judge whether the browser's system resource operation is a legal operation, and for the legal operation, not to redirect the browser's system resource operation to the virtual environment pre-established.

14. The apparatus of claim 11, further comprising a module configured to close the virtual environment.

15. A computer readable recording medium on which a program for executing the method of claim 1 is recorded.

16. The method of claim 3, wherein the virtual environment pre-established is a virtual machine pre-created, and in the virtual machine the loading of the browser and write operations of the browser are performed.

17. The method of claim 7, wherein the browser's system resource operation judged as legal operation at least comprises one of the following operations:
synchronizing save-type operations to the real environment; or taking the operation to the system effective in the real environment; or modifying a registry of the system.
